(19) United States
(12) Patent Application Publication
(10) Pub. No.: US 2026/0097336 A1
(43) Pub. Date: Apr. 9, 2026

(54) FILTER ELEMENT, DRAIN CLOSURE ELEMENT AND FILTER SYSTEM

(71) Applicant: MANN+HUMMEL GmbH, Ludwigsburg (DE)

(72) Inventor: Christian VOGT, Ludwigsburg (DE)

(21) Appl. No.: 19/416,019

(22) Filed: Dec. 11, 2025

Related U.S. Application Data
(63) Continuation of application No. PCT/EP2024/065733, filed on Jun. 7, 2024.

(30) Foreign Application Priority Data
Jul. 7, 2023 (DE) 10 2023 117 941.1

(51) Int. Cl. B01D 35/16; B01D 29/15; B01D 35/00

(52) U.S. Cl. CPC B01D 35/16; B01D 29/15; B01D 35/005; B01D 2201/291; B01D 2201/347

(57) ABSTRACT

A filter element has a filter medium surrounding an element interior and an end plate connected to an axial end of the filter medium. The end plate has an element drain opening to the element interior and a first seal element, surrounding the element drain opening and oriented radially inwardly. The element drain opening is closable or is closed by a drain closure element arranged at a filter housing. The first seal element contacts sealingly a first seal surface of the drain closure element. The end plate has a receiving portion surrounding the element drain opening and provided with a second seal element seal-tightly contacting a seal surface of the filter housing. The receiving portion has a third seal element sealingly contacting a second seal surface of the drain closure element. A filter system has such a filter element and such a drain closure element.

### CROSS-REFERENCE TO RELATED APPLICATIONS

This application is a continuation application of international application No. PCT/EP2024/065733 having an international filing date of June 7, 2024, and designating the United States, the international application claiming a priority date of July 7, 2023, based on prior filed German patent application No. 102023117 941.1, the entire contents of the aforesaid applications being incorporated herein by reference.

### BACKGROUND

The invention concerns a filter element for a filter system for filtering a fluid, for example oil or fuel, for example of an internal combustion engine, for example of a unit including electric motor, axle, and transmission (“e-Axle”), a drain closure element for a filter system as well as a filter system for filtering a fluid, for example oil or fuel, for example of an internal combustion engine, for example of a unit including electric motor, axle, and transmission (“e-Axle”).

In filter housings of openable suspendedly arranged filter systems, i.e., having a housing part releasable in downward direction, it is necessary that, prior to unscrewing the housing cover, for example, when servicing the filter system, a drain opening is opened so that the liquid contained in the housing may drain. For this purpose, filters are usually provided with closure plugs, closure screws or the like. For sealing the raw side and the clean side, these closure plugs require respectively a seal, for example, an O-ring.

From WO 2014/082762 a filter system for a fluid, for example oil, fuel, water or air, for example of an internal combustion engine, for example of a motor vehicle, is known, with a filter housing which includes a fluid inlet and a fluid outlet and in which a filter element is arranged such that it separates the fluid inlet from the fluid outlet. Furthermore, the filter system includes a drain device for fluid contained in the filter housing which includes a housing drain opening which is closable by a closure means. A separation element which separates a clean fluid side of the filter element from a raw fluid side includes an element drain opening which is closable by the closure means. By means of the closure means, the housing drain opening and the element drain opening are thus closed in the closed state of the drain device.

WO 2019/120976 describes a filter element of a filter for a liquid, for example oil or fuel, for example of an internal combustion engine, for example of a motor vehicle, with a filter medium which circumferentially contiguously surrounds an element interior in relation to a virtual axis and which is connected to an end member at at least one axial end face in relation to the axis. In this context, the end member includes a filter element emptying opening, which surrounds the axis and is connected to the element interior, and a filter element seal surface or filter element sealing surface of a filter element seal device which circumferentially contiguously surrounds the filter element emptying opening and by means of which the filter element emptying opening may be closed when the filter element is assembled. The filter element seal device includes at least one circumferentially contiguous seal in relation to the axis which is fastened to the filter element.

WO 2019/120981 describes a similar filter element in which the filter element seal surface or filter element sealing surface is oriented axially with at least one directional component in relation to the axis.

EP 2072103 A1 discloses a filter element for an oil filter of an internal combustion engine, for example for motor vehicles, in which the filter element includes a filter bypass valve fastened thereat in such a way that the filter element together with the filter bypass valve forms a constructive unit provided for common exchange. The filter bypass valve is connected fixedly to the filter element so that the user is forced to exchange the filter bypass valve together with the filter element during regular servicing work.

### SUMMARY

It is an object of the invention to provide a filter element, improved in respect to a drain solution, for a filter system for filtering a fluid, for example oil or fuel, for example of an internal combustion engine.

A further object of the invention is to provide a drain closure element, improved in respect to a drain solution, for a filter system for filtering a fluid, for example oil or fuel, for example of an internal combustion engine.

A further object resides in providing a filter system, improved in respect to a drain solution, for filtering a fluid, for example oil or fuel, for example of an internal combustion engine, with such a filter element.

The aforementioned object is solved according to an aspect of the invention by a filter element for a filter system for filtering a fluid, for example oil or fuel, for example of an internal combustion engine, for example of a unit including electric motor, axle, and transmission (“e-Axle”), with at least one filter medium which surrounds an element interior and which is connected to an end plate at least at one axial end face in relation to a longitudinal axis, wherein the end plate includes an element drain opening, which is connected in fluid communication to the element interior and includes at least one first seal element, surrounding the element drain opening and oriented radially inwardly, and which, when installed as intended in a filter housing of the filter system, is closable and/or is closed by a drain closure element arranged at a housing part of the filter housing, wherein the first seal element is configured to seal-tightly contact a first seal surface of the drain closure element, wherein the end plate includes a receiving portion configured to guide the drain closure element and surrounding the element drain opening at least in sections and including at least one second circumferential seal element which, when installed as intended in the filter housing, seal-tightly contacts a seal surface of the housing part, wherein the receiving portion includes at least one third circumferential seal element which seal-tightly contacts a second seal surface of the drain closure element.

According to a further aspect of the invention, the further object is solved by a drain closure element for a filter system with a filter element for filtering a fluid, for example oil or fuel, for example of an internal combustion engine, for example of a unit including electric motor, axle, and transmission (“e-Axle”), including an element member with a first seal surface for sealing against a seal element of an element drain opening of the filter element and with a second seal surface for sealing against a seal element of a receiving portion of the filter element, wherein the seal surfaces surround circumferentially a longitudinal axis, respectively, wherein the drain closure element is connectable to a filter housing of the filter system by means of a rotation and/or plug-in movement in relation to the longitudinal axis.

According to a further aspect of the invention, the further object is solved by a filter system for filtering a fluid, for example oil or fuel, for example of an internal combustion engine, for example of a unit including electric motor, axle, and transmission (“e-Axle”), with a filter housing which includes at least one fluid inlet and at least one fluid outlet and in which a filter element is arranged such that it separates the at least one fluid inlet from the at least one fluid outlet, and with a drain device for fluid contained in the filter housing which includes at least one housing drain opening which, in operation as intended, is closable and/or is closed by a drain closure element, wherein the filter element includes at least one filter medium which surrounds an element interior and which is connected at least at one end face to an end plate, wherein the end plate includes an element drain opening which is connected in fluid communication to the element interior and, in operation as intended, is closable and/or is closed by the drain closure element.

Embodiments and advantages of the invention result from the following description, and the accompanying drawings.

According to an aspect of the invention, a filter element for a filter system for filtering a fluid, for example oil or fuel, for example of an internal combustion engine, for example of a unit including electric motor, axle, and transmission (“e-Axle”), is proposed, with at least one filter medium which surrounds an element interior and which is connected to an end plate at least at one axial end face in relation to the longitudinal axis. The end plate includes an element drain opening which is connected in fluid communication to the element interior and includes at least one first seal element surrounding the element drain opening and oriented radially inwardly and which, when installed as intended in a filter housing of the filter system, is closable and/or is closed by a drain closure element arranged at a housing part of the filter housing. The first seal element is configured to seal-tightly contact a first seal surface of the drain closure element. The end plate includes a receiving portion which is configured to guide the drain closure element, which circumferentially surrounds the element drain opening, and which includes at least one second circumferential seal element which, when installed as intended in the filter housing, seal-tightly contacts a seal surface of the housing part. The receiving portion includes at least one third circumferential seal element which seal-tightly contacts a second seal surface of the drain closure element.

The proposed filter element includes an element drain opening in order to allow the fluid contained in the filter element to drain when changing the filter element. This element drain opening may be closed by a drain closure element which simultaneously closes a housing drain opening. The filter element includes all seal elements in order to seal in relation to the drain closure element. When exchanging the filter element, all seal elements are thus also exchanged at the same time. The drain closure element may be re-used in this way.

The seal elements may be but need not necessarily be O-rings. For example, the first seal element may be arranged at the end plate and may be embodied as a plastic lip of the material of the end plate. The other seal elements may however be present being cut from plastic material. The seal elements may be present as O-rings, may be molded on or may be configured as a seal with two lips.

When the drain closure element is slowly unscrewed from the filter housing, in a first step, initially only the housing drain opening may be opened and the raw fluid contained in the filter housing may be drained. Only upon further unscrewing of the drain closure element, in a second step, the element drain opening is then also opened so that the filtered clean fluid contained in the filter element interior may also be drained.

According to a configuration of the filter element, the first, second, and third seal elements may be designed as radially sealing seal elements. In this manner, a reliable sealing action of the drain closure element in relation to the filter element and the filter housing may be realized.

According to an embodiment of the filter element, the second and third seal elements may be arranged on a radially outer side of the receiving portion. In this way, the second seal element may seal against the filter housing and the third seal element against a radially outwardly positioned contour of the drain closure element.

In an alternative embodiment, the second seal element may be arranged on the radially outer side of the receiving portion and the third seal element on a radially inner side of the receiving portion. In this way, the second seal element may seal against the filter housing and the third seal element against a radially inwardly positioned contour of the drain closure element.

According to a configuration of the filter element, the second seal element and the third seal element may include an identical radial distance in relation to the longitudinal axis. The seal surfaces of the filter housing and of the drain closure element may thus be positioned at the same radial distance from the longitudinal axis. In this way, a beneficial mounting of the drain closure element is possible.

In an alternative configuration, one of the second and third seal elements may be arranged at a larger radial distance in relation to the longitudinal axis than the other one of the second and third seal elements. Such a stepped arrangement of the seal surfaces may also be advantageous for a sealing action upon mounting of the drain closure element.

According to a configuration of the filter element, the second seal element may be arranged along the longitudinal axis between the first seal element and the third seal element. In this way, the second seal element may seal against the filter housing and the third seal element against a radially inwardly positioned contour of the drain closure element.

In an alternative configuration, the second seal element may be arranged at the same level of the longitudinal axis as the third seal element. Such an arrangement is for example advantageous when the second seal element is arranged at the radially outer side and the third seal element at the radially inner side of the receiving portion.

According to an embodiment of the filter element, the receiving portion may be connected to the end disk so as to be movable, for example axially limited, along the longitudinal axis. For example, in this context the receiving portion and the end disk may include complementary connecting elements of a connection, for example of a snap connection, which for example permits an axially limited movement of the receiving portion along the longitudinal axis relative to the end plate. Such a movement of the receiving portion against the filter element may be advantageous in use of the filter element when strong pressure pulsations may occur upon filtration of the fluid. Such pulsations may be, for example, harmful for this first seal element at the clean side of the filter element.

According to an embodiment of the filter element, the first seal element may be integrated into the end plate. For example, in this context the first seal element may be formed as one piece together with the end plate. In this way, the first seal element may be manufactured efficiently. Also, in this way a reliable sealing action against the drain closure element may be provided.

According to a further aspect of the invention, a drain closure element is proposed for a filter system with a filter element for filtering a fluid, for example oil or fuel, for example of an internal combustion engine, for example of a unit including electric motor, axle, and transmission (“e-Axle”). The drain closure element includes an element member with a first seal surface for sealing in relation to a seal element of an element drain opening of the filter element and with a second seal surface for sealing against a seal element of a receiving portion of the filter element, wherein the seal surfaces surround a longitudinal axis circumferentially, respectively. The drain closure element is connectable to a filter housing of the filter system by means of a rotation and/or plug-in movement in relation to the longitudinal axis.

The proposed drain closure element serves to close an element drain opening of the filter element. Through the element drain opening, the fluid contained in the filter element may drain when exchanging the filter element. The drain closure element closes further a housing drain opening of the filter housing of the filter system.

When the drain closure element is slowly unscrewed from the filter housing, in a first step, initially only the housing drain opening may be opened and the raw fluid contained in the filter housing may be drained. Only upon further unscrewing of the drain closure element, in a second step, the element drain opening is then also opened so that the filtered clean fluid contained in the filter element may also be drained.

The filter element may include all seal elements in order to seal in relation to the drain closure element. When exchanging the filter element, all seal elements are thus exchanged also at the same time. The drain closure element may be reused in this way.

According to an embodiment of the drain closure element, the element member may include a connection part and a centering part, wherein the centering part includes the first seal surface and the connection part the second seal surface. In this manner, the drain closure element may seal-tightly close the element drain opening of the filter element and the housing drain opening of the filter housing.

According to an embodiment of the drain closure element, the centering part may be connected to the connection part so as to be movable, for example axially limited, along the longitudinal axis. For example, in this context the connection part and the centering part may include complementary connection elements of the connection which permit a for example, axially limited movement of the centering part along the longitudinal axis relative to the connection part. Such a movement of the centering part against the connection part may be advantageous in use of the filter element when strong pressure pulsations upon filtering the fluid may occur. Such pulsations may be, for example, harmful for the first seal element at the clean side of the filter element.

According to an embodiment of the drain closure element, when arranged as intended, a drain channel guided to an exterior side of the filter housing may be present. For example, the drain channel may be present in the connection part in this context. After partial unscrewing of the drain closure element from the filter housing, raw fluid contained in the filter housing may drain through the drain channel.

According to a further aspect of the invention, a filter system with a filter housing for filtering a fluid, for example oil or fuel, for example of an internal combustion engine, for example of a unit including electric motor, axle, and transmission (“e-Axle”), is proposed, which includes at least one fluid inlet and at least one fluid outlet and in which a filter element is arranged such that it separates the at least one fluid inlet from the at least one fluid outlet, and with a drain device for fluid contained in the filter housing, which includes at least one housing drain opening which, in operation as intended, may be closed or is closed by a drain closure element. The filter element includes at least one filter medium which surrounds an element interior and which is connected to an end plate at least at one end face. In this context, the end plate includes an element drain opening which is connected in fluid communication to the element interior and, in operation as intended, is closable and/or is closed by the drain closure element.

The filter element of the proposed filter system includes an element drain opening in order to permit the fluid contained in the filter element to drain when exchanging the filter element. This element drain opening may be closed by a drain closure element which at the same time closes a housing drain opening. The filter element includes all seal elements in order to seal against the drain closure element. When exchanging the filter element, all seal elements are thus also exchanged at the same time. The drain closure element may be reused in this way.

The seal elements may be but need not necessarily be O-rings. For example, the first seal element may be arranged at the end plate and may be formed as a plastic lip of the material of the end plate. The other seal elements may however be present being cut from plastic material. The seal elements may be present as O-rings, molded on or be embodied as a seal with two lips.

When the drain closure element is unscrewed slowly from the filter housing, in a first step, initially only the housing drain opening may be opened and the raw fluid contained in the filter housing may be drained. Only upon further unscrewing of the drain closure element, in a second step, the element drain opening is then also opened so that filtered clean fluid contained in the filter element may also be drained.

According to an embodiment of the filter system, the drain closure element may include an element member with a first seal surface for sealing against a seal element of the element drain opening of the filter element and with a second seal surface for sealing against a seal element of a receiving portion of the filter element, which surround a longitudinal axis circumferentially, respectively. The drain closure element is connectable and/or connected to the filter housing by means of a rotation and/or plug-in movement in relation to the longitudinal axis. In this manner, the drain closure element may seal-tightly close the element drain opening of the filter element and the housing drain opening of the filter housing. The element drain opening and the housing drain opening may be closed and opened again by means of the drain closure element.

According to an embodiment of the filter system, the element member may include a connection part and a centering part, wherein the centering part includes the first seal surface and the connection part includes the second seal surface. The drain closure element may seal-tightly close the element drain opening of the filter element and the housing drain opening of the filter housing in this manner.

According to an embodiment of the filter system, the centering part may be connected to the connection part so as to be moveable, for example limited axially, along the longitudinal axis. For example, in this context the connection part and the centering part may include complementary connection elements of a connection, for example of a snap connection, which permits for example an axially limited movement of the centering part along the longitudinal axis relative to the connection part. Such a movement of the centering part relative to the connection part may be advantageous in use of the filter element when strong pressure pulsations upon filtration of the fluid may occur. Such pulsations may be harmful for the first seal element at the clean side of the filter element.

According to an embodiment of the filter system, when arranged as intended, a drain channel guided to an exterior side of the filter housing may be present. For example, the drain channel may be present in the connection part. Through the drain channel, which may be arranged in the drain closure element, raw fluid contained in the filter housing may drain after partial unscrewing of the drain closure element from the filter housing.

### BRIEF DESCRIPTION OF THE DRAWINGS

Further advantages result from the following drawing description. In the drawings, embodiments of the invention are illustrated. The drawings and the

accompanying description contain numerous features in combination. A person of skill in the art will consider the features expediently also individually and combine them to expedient further combinations.

FIG. 1 shows an isometric illustration of a filter system for filtering a fluid, for example oil or fuel, for example of an internal combustion engine, according to an embodiment of the invention.

FIG. 2 shows a section illustration of the filter system according to FIG. 1.

FIG. 3 shows an enlarged illustration of a region of a drain device of the filter system according to FIG. 2.

FIG. 4 shows a section illustration of the filter system according to a further embodiment of the invention.

FIG. 5 shows an enlarged illustration of a region of the drain device of the filter system according to FIG. 4.

### DETAILED DESCRIPTION

In the drawing figures, same or same-type components are identified with like reference characters. The drawing figures show only examples and are not to be understood as limiting.

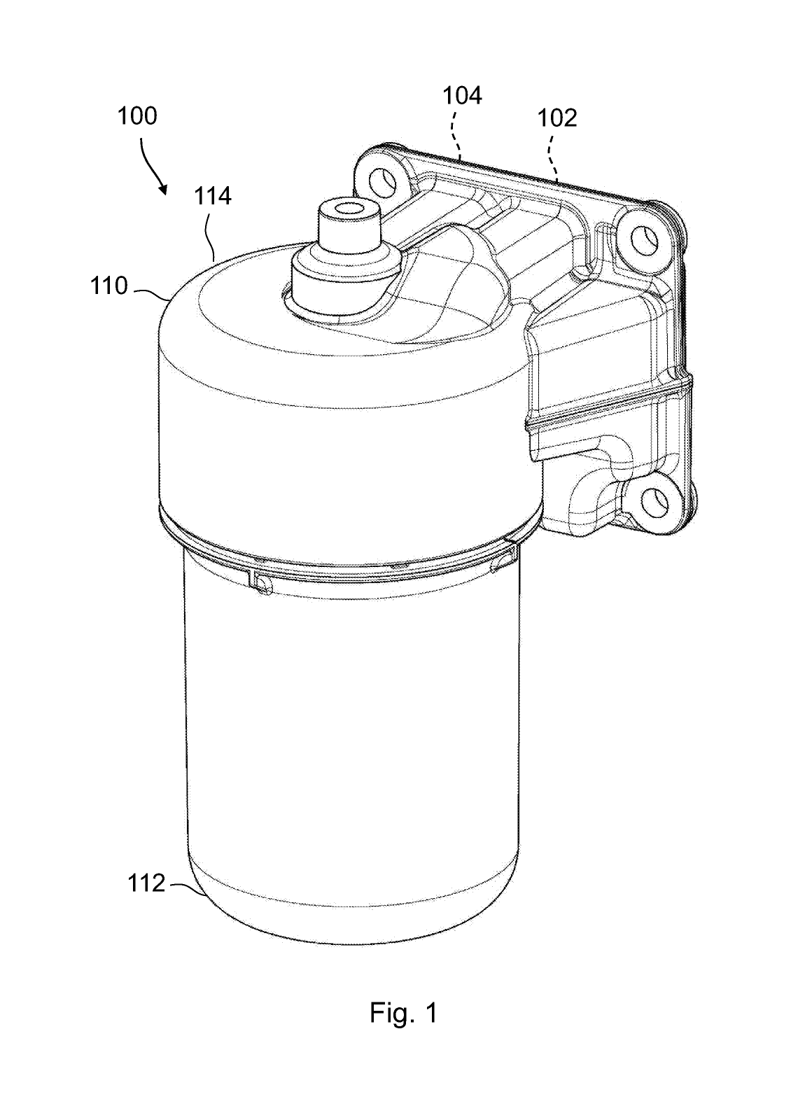

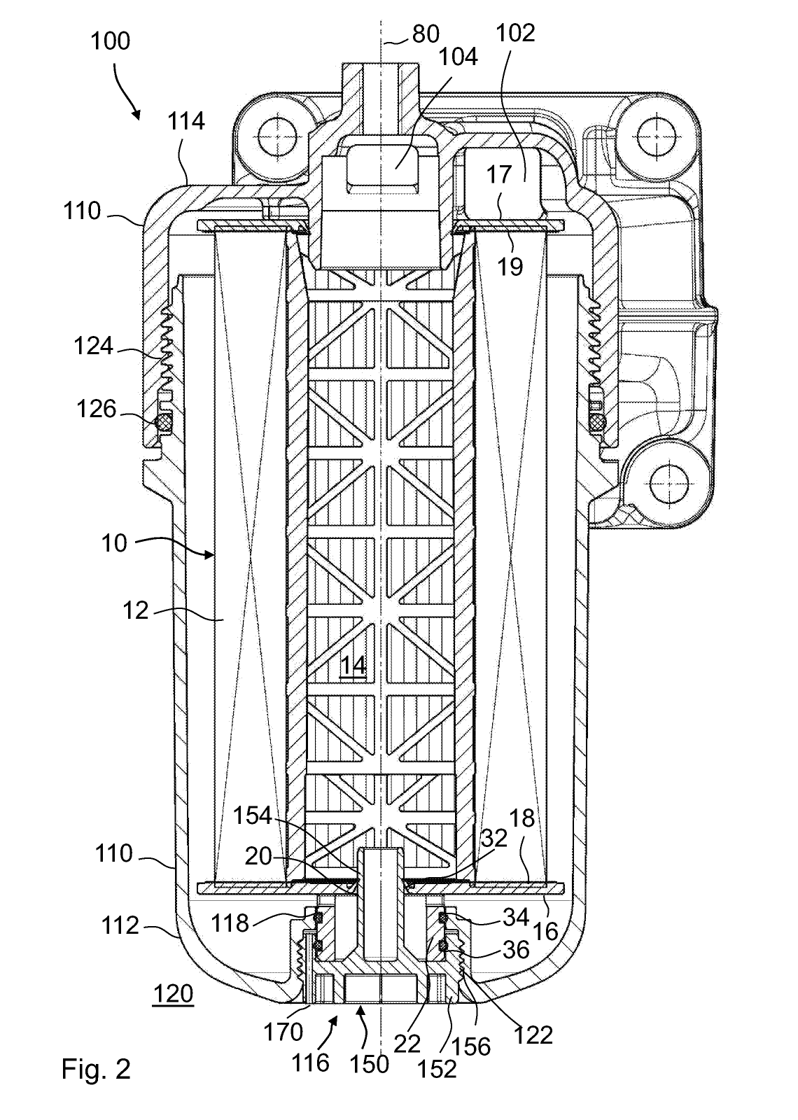

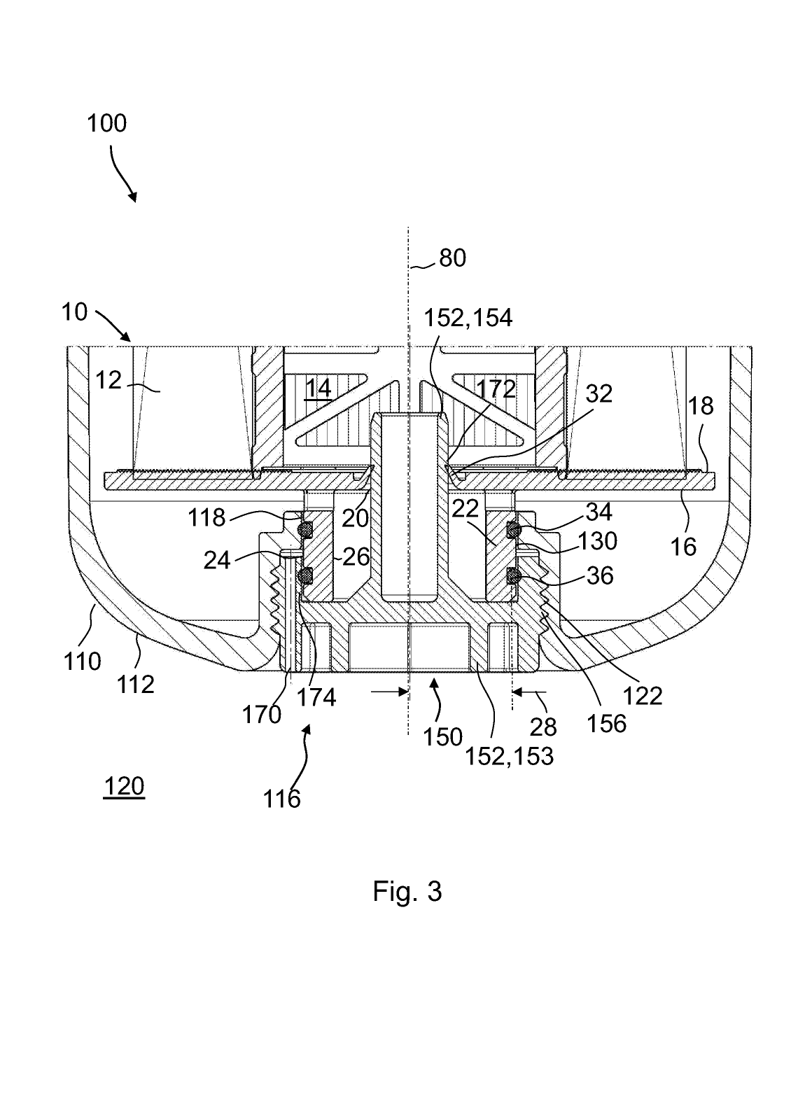

For explaining the invention, FIG. 1 shows an embodiment of a filter system 100 for filtering a fluid, for example oil or fuel, for example of an internal combustion engine, for example of a unit comprising electric motor, axle, and transmission (“e-Axle”), in an isometric illustration. FIG. 2 shows a section illustration of the filter system 100 according to FIG. 1. In FIG. 3, an enlarged illustration of a region of a drain device 116 of the filter system 100 may be seen.

The filter system 100 comprises a filter housing 110 with first and second housing parts 112, 114 which are connected by a screw thread 124. The two housing parts 112, 114 are seal-tightly closed by a housing seal 126, for example, an O ring. The second housing part 114 comprises a fluid inlet 102 and a fluid outlet 104. In the filter housing 110, a filter element 10 is arranged such that it separates the at least one fluid inlet 102 from the at least one fluid outlet 104.

The filter system 100 comprises a drain device 116 for fluid contained in the filter housing 110 which comprises a housing drain opening 118 which, in operation as intended, is closable and/or is closed by a drain closure element 150.

The drain closure element 150 may be connected to the filter housing 110 by means of a rotation and/or plug-in movement in relation to the longitudinal axis 80. For this purpose, the drain closure element 150 comprises an outer thread 156 and the housing part 112 of the filter housing 110 an inner thread 122.

The filter element 10 comprises a filter medium 12 which surrounds an element interior 14 and is connected to end plates 18, 19 at the axial end faces 16, 17.

Raw fluid flowing in through the fluid inlet 102 flows tangentially toward the filter element 10, passes through the filter medium 12 of the filter element 10 into the element interior 14, and exits the filter element 10 through the axially arranged fluid outlet 104.

The end plate 18 comprises an element drain opening 20 which is connected in fluid communication to the element interior 14 and comprises at least one first seal element 32 surrounding the element drain opening 20 and oriented radially inwardly. For installation of the filter element 10 in the filter housing 110 of the filter system 100 as intended, the element drain opening 20 is closable and/or is closed by the drain closure element 150 arranged in the housing part 112 of the filter housing. In this context, the first seal element 32 is configured to seal-tightly contact the first seal surface 172 of the drain closure element 150.

The first seal element 32 is integrated into the end plate 18. For example, in this context the first seal element 32 may be configured as one piece together with the end plate 18.

The end plate 18 comprises a receiving portion 22 configured to guide the drain closure element 150. The receiving portion 22 surrounds the element drain opening 20 circumferentially and comprises a second circumferential seal element 34 which contacts seal-tightly, when installed as intended in the filter housing 110, the seal surface 130 of the housing part 112. The receiving portion 22 comprises a third circumferential seal element 36 which seal-tightly contacts the second seal surface 174 of the drain closure element 150.

As seen for example in FIG. 3, the drain closure element 150 comprises an element member 152 with the first seal surface 172 for sealing against the seal element 32 of the element drain opening 20 of the filter element 10 and with the second seal surface 174 for sealing against the seal element 36 of the receiving portion 22 of the filter element 10. The seal surfaces 172, 174 surround the longitudinal axis 80 circumferentially, respectively.

The element member 152 of the drain closure element 150 comprises a connection part 153 and a centering part 154. In this context, the centering part 154 comprises the first seal surface 172 and the connection part 153 comprises the second seal surface 174.

The first, second and third seal elements 32, 34, 36 are configured as radially sealing seal elements, respectively.

The second and third seal elements 34, 36 are arranged on a radially outer side 24 of the receiving portion 22.

In an alternative embodiment, not illustrated, the third seal element 36 could also be arranged at the inner side 26 however. For this purpose, the contour of the connection part 153 would also have to be changed and comprise a radially inwardly arranged and radially outwardly oriented seal surface 174.

The second seal element 34 and the third seal element 36 comprise in the embodiment illustrated in the drawing figures an identical radial distance 28 to the longitudinal axis 80.

In a stepped arrangement, not illustrated, one of the second and third seal elements 34, 36 could however be arranged also at a larger radial distance in relation to the longitudinal axis 80 than the other one of the second and third seal elements 36, 34.

The second seal element 34 is arranged along the longitudinal axis 80 between the first seal element 32 and the third seal element 36.

At the connection part 153, a drain channel 170 is present which is guided to an exterior side 120 of the filter housing 110 when arranged as intended. After partial unscrewing of the drain closure element 150 from the filter housing 110, raw fluid contained in the filter housing 110 may drain by means of the drain channel 170.

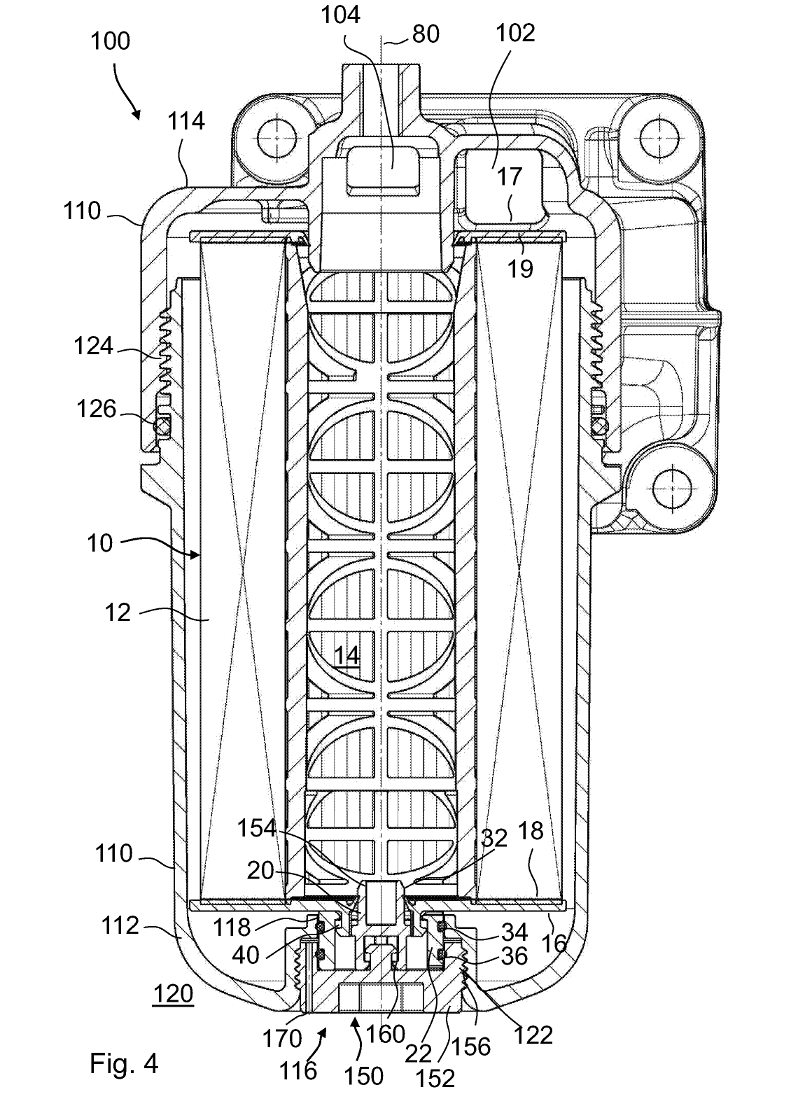

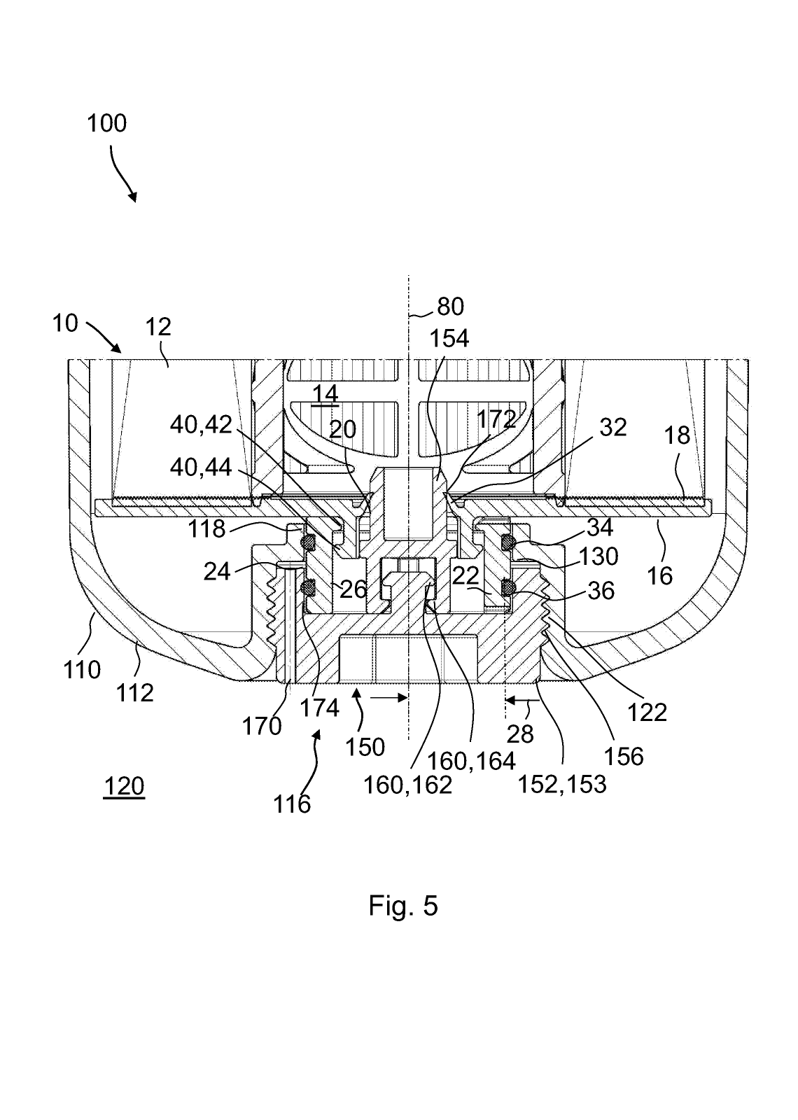

FIG. 4 shows a section illustration of a filter system 100 according to a further embodiment of the invention. In FIG. 5, an enlarged illustration of the region of a drain device 116 of the filter system 100 may be seen.

The filter system 100 is configured similar to the filter system 100 illustrated in FIGS. 1 to 3. The difference is that in the embodiment illustrated in FIGS. 4 and 5 relative movements of the filter element 10 against the filter housing 110, caused by pressure pulsations in filter operation, may be tolerated.

For this purpose, the receiving portion 22 is connected to the end plate 18 so as to be movable, for example axially limited, along the longitudinal axis 80. The receiving portion 22 and the end plate 18 comprise complementary connection elements 42, 44 of a connection 40, for example of a snap connection 40, which permits for example an axially limited movement of the receiving portion 22 along the longitudinal axis 80 in relation to the end plate 18. When mounting the filter element 10, the receiving portion 22 may snap with its connection element 42 at the connection element 44 arranged at the end plate 18.

Furthermore, the centering part 154 of the drain closure element 150 is connected to the connection part 153 so as to be movable, for example axially limited, along the longitudinal axis 80. The connection part 153 and the centering part 154 comprise for this purpose complementary connection elements 162, 164 of a connection 160, for example of a snap connection 160, which permits for example an axially limited movement of the centering part 154 along the longitudinal axis 80 in relation to the connection part 153. When mounting the drain closure element 150, the connection part 153 may snap into place with its connection element 162 at the connection element 164 arranged at the centering element 154.

### Reference Characters

10 filter element

12 filter medium

14 element interior

16 end face

17 end face

18 end plate

19 end plate

20 element drain opening

22 receiving portion

24 outer side

26 inner side

28 radial distance

32 first seal element

34 second seal element

36 third seal element

40 connection

42 connection element

44 connection element

80 longitudinal axis

100 filter system

102 fluid inlet

104 fluid outlet

110 filter housing

112 housing part

114 housing part

116 drain device

118 housing drain opening

120

exterior side

122 inner thread

124 screw thread

126 housing seal

130 seal surface

150 drain closure element

152 element member

153 connection part

154 centering part

156 outer thread

160 connection

162 connection element

164 connection element

170 drain channel

172 first seal surface

174

second seal surface

That which is claimed is:

1. A filter element for filtering a fluid, the filter element comprising:
at least one filter medium surrounding an element interior;
an end plate connected to the at least one filter medium at an axial end face thereof in relation to a longitudinal axis;
wherein the end plate comprises an element drain opening connected in fluid communication to the element interior and comprising at least one first circumferential seal element, extending circumferentially around the element drain opening and oriented radially inwardly;
wherein the element drain opening, when installed in a filter housing is configured to be closable and/or is closed by a drain closure element arranged at the filter housing;
wherein the at least one first circumferential seal element is configured to contact seal-tightly a first seal surface of the drain closure element;
wherein the end plate comprises a receiving portion configured to guide the drain closure element and circumferentially surround the element drain opening;
wherein the receiving portion comprises at least one second circumferential seal element configured to seal-tightly contact a seal surface of the filter housing;
wherein the receiving portion comprises at least one third circumferential seal element configured to seal-tightly contact a second seal surface of the drain closure element.

2. The filter element according to claim 1, wherein the at least one first circumferential seal element, the at least one second circumferential seal element, and the at least one third circumferential seal element are radially sealing seal elements.

3. The filter element according to claim 1, wherein the at least one second circumferential seal element and the at least one third circumferential seal element are arranged on a radially outer side of the receiving portion.

4. The filter element according to claim 1, wherein the at least one second circumferential seal element and the at least one third circumferential seal element comprise an identical radial distance in relation to the longitudinal axis.

5. The filter element according to claim 1, wherein the at least one second circumferential seal element is arranged along the longitudinal axis between the at least one first circumferential seal element and the at least one third circumferential seal element.

6. The filter element according to claim 1, wherein the receiving portion is connected to the end plate so as to be movable relative to the end plate along the longitudinal axis.

7. The filter element according to claim 6, wherein the receiving portion and the end plate comprise complementary connection elements of a connection, respectively, and wherein the connection permits a limited axial movement of the receiving portion along the longitudinal axis in relation to the end plate.

8. A drain closure element for the filter element according to claim 1, the drain closure element comprising:
an element member comprising a first seal surface configured to seal against the at least one first circumferential seal element of the element drain opening of the filter element and further comprising a second seal surface configured to seal against the at least one third circumferential seal element of the receiving portion of the filter element;
wherein the first seal surface and the second seal surface circumferentially surround a longitudinal axis, respectively;
wherein the drain closure element is configured to connect to the filter housing by a rotation and/or plug-in movement in relation to the longitudinal axis.

9. The drain closure element according to claim 8, wherein the element member comprises a connection part and a centering part, wherein the centering part comprises the first seal surface and wherein the connection part comprises the second seal surface.

10. The drain closure element according to claim 9, wherein the centering part is connected to the connection part so as to be movable along the longitudinal axis.

11. The drain closure element according to claim 10, wherein the connection part and the centering part comprise complementary connection elements of a connection, respectively, and wherein the connection permits an axially limited movement of the centering part in relation to the connection part along the longitudinal axis.

12. The drain closure element according to claim 9, further comprising a drain channel guided to an exterior side of the filter housing.

13. The drain closure element according to claim 12, wherein the drain channel is disposed in the connection part.

14. A filter system for filtering a fluid, the filter system comprising:
a filter housing comprising at least one fluid inlet and at least one fluid outlet;
a filter element arranged in the filter housing so as to separate the at least one fluid inlet from the at least one fluid outlet;
a drain device comprising at least one housing drain opening configured to drain the fluid from the filter housing;
a drain closure element configured to be closable and/or to close the at least one housing drain opening;
wherein the filter element comprises at least one filter medium surrounding an element interior and further comprises an end plate connected to the at least one filter medium at an axial end face thereof in relation to a longitudinal axis;
wherein the end plate comprises an element drain opening connected in fluid communication to the element interior;
wherein the element drain opening is configured to be closable and/or is closed by the drain closure element.

15. The filter system according to claim 14, wherein the drain closure element comprises an element member comprising a first seal surface configured to seal against a seal element of the element drain opening of the filter element and further comprising a second seal surface configured to seal against a seal element of a receiving portion of the filter element, wherein the first seal surface and the second seal surface circumferentially surround the longitudinal axis, respectively, and wherein the drain closure element is configured to connect to the filter housing by a rotation and/or plug-in movement in relation to the longitudinal axis.

16. The filter system according to claim 14, wherein the element member comprises a connection part and a centering part, and wherein the centering part comprises the first seal surface and the connection part comprises the second seal surface.

17. The filter system according to claim 16, wherein the centering part is connected to the connection part so as to be moveable along the longitudinal axis.

18. The filter system according to claim 17, wherein the connection part and the centering part comprise complementary connection elements of a connection, respectively, and wherein the connection permits an axially limited movement of the centering part along the longitudinal axis in relation to the connection part.

19. The filter system according to claim 16, further comprising a drain channel guided to an exterior side of the filter housing when arranged as intended.

20. The filter system according to claim 19, wherein the drain channel is disposed in the connection part.
